(19) United States
(12) Patent Application Publication
(10) Pub. No.: US 2008/0203043 A1
(43) Pub. Date: Aug. 28, 2008

(54) Apparatus and Method for Dismantling Shelving Units

(76) Inventors: Dirk Marinus Poortvliet, Zuilichem (NL); D. J. Koning, Son En Breugel (NL); W. Struijk, Delwijnen (NL)

Correspondence Address: HOWREY LLP-EU, C/O IP DOCKETING DEPARTMENT, 2941 FAIRVIEW PARK DR., SUITE 200, FALLS CHURCH, VA, 22042, US

(21) Appl. No.: 11/660,316

(22) PCT Filed: Aug. 17, 2005
(86) PCT No.: PCT/EP05/54044

§ 371 Date: Nov. 6, 2007

(30) Foreign Application Priority Data
Aug. 18, 2004 (NL) 1026865
Jan. 10, 2005 (NL) 1027987

(51) Int. Cl. A47B 47/00; A01G 9/14; B62B 3/02

(52) U.S. Cl. 211/189; 280/47.11

(57) ABSTRACT

An apparatus (20) and method for dismantling shelving units, in particular trolleys (1) for transporting flowers, plants and the like. The apparatus (20) comprises a gripping device (22) for gripping the shelves (4) as a whole, to allow separation of the shelves (4) from the remainder of the trolley (1). The gripping device (22) is then operable to controllably deposit the shelves (4) e.g. in a stack or onto a conveyor. In order to adapt to variations in the size and position of the shelves (4), the gripping device (22) may be flexible.

### BACKGROUND OF THE INVENTION

1. Field of the Invention

The present invention relates to an apparatus and method for dismantling shelving units, in particular trolleys for transporting flowers, plants and the like. The invention further relates to systems comprising in combination a plurality of such shelving units and an apparatus for dismantling and stacking the shelving units.

2. Description of the Related Art

Shelving units are known in various fields. Particularly in commercial fields, such shelving units may be assembled for use and subsequently require dismantling for the purpose of transport or storage. In certain fields, this dismantling may take place frequently and involve considerable manpower.

It is known in the horticultural industry to use trolleys, sometimes referred to as “Danish carts” to transport flowers and other plants. These trolleys are in the form of mobile shelving units comprising a rectangular base of approximately 1 m by 50 cm, provided with wheels. Upright frame elements are inserted into sockets at the four corners of the base and a number of shelves or planks are supported by the frame elements. The shelves are provided with hooks or pins for engagement with appropriate slots in the frame elements. The number of shelves and their spacing will vary according to the plants being transported. It is estimated that 21 million such trolleys are in operation worldwide and on average each trolley will rotate back to a central depot four times in a given year.

On returning empty to a depot, the trolleys are preferably knocked-down or dismantled to save space. The shelves are removed one by one from the frame elements by manipulating the hooks out of the slots. Each shelf may then be stacked e.g. on an empty trolley. Broken or damaged shelves may be discarded or separated. Finally, the uprights are disengaged from the base and the bases and uprights stacked separately. This operation involves considerable manpower

The dismantling of such trolleys does not lend itself to automation. In particular, each trolley is assembled differently with varying number of shelves and different spacing between the shelves. Furthermore, different forms of shelf have been produced and these are now randomly distributed throughout the industry. As a consequence, the shelves found on a single individual trolley may vary from one another e.g. in their lateral dimensions by up to 2 cm. Additionally, shelves may be warped or broken, it may be difficult to release them from the uprights and the uprights may also jam in the sockets in the base.

There is thus clearly a need to provide a system and apparatus whereby at least some of the inconveniences of dismantling such trolleys may be overcome.

### BRIEF SUMMARY OF THE INVENTION

According to the present invention there is provided an apparatus for dismantling a shelving unit of the type having a frame and a plurality of removable shelves supported by the frame, the apparatus comprising a gripping device for concurrently gripping the plurality of shelves to allow separation of the frame from the shelves, the gripping device being subsequently operable to controllably deposit the shelves. The gripping device may be operable by means of an appropriate drive mechanism as described below. By concurrently gripping the shelves it has been found technically easier to adapt to different numbers and positions of the shelves within a shelving unit. In the present context, concurrently is intended to define that the shelves are gripped together. This does not necessarily imply that the action of gripping takes place simultaneously. Furthermore, by gripping all or most of the shelves, the frame may be free to move with respect to the gripping device and can be more easily manipulated e.g. for removal from a base element. In this way the frame is removed from the shelves rather than vice-versa as is more conventionally the case e.g. by manual dismantling.

According to a preferred embodiment the apparatus may further comprise a raising device for vertically displacing the gripping device and shelves as a unit with respect to at least part of the frame. This is particularly useful for disconnecting e.g. parts of the frame on which the shelves are supported from a base element. It may also serve to disconnect the shelves themselves from the frame. In this context it is important to note that the gripping device must be able to provide sufficient force or grip on the shelves to assure this function, in particular when the joint to be disconnected has a tendency to jam.

According to a further feature of a preferred embodiment the apparatus may comprise a transport device for laterally displacing the gripping device and shelves as a unit with respect to at least part of the frame. In this way, the shelves may be displaced sideways for stacking e.g. on another base unit. Clearly, this may be achieved by moving the gripping device with respect to the frame part or vice-versa.

The invention is particularly applicable to shelving units having shelves of differing dimensions. To this effect the gripping device preferably comprises flexible jaws for gripping such shelves. These flexible jaws can thus compensate for any differences in dimension between the shelves while still exerting a sufficient force on each shelf. In particular, the gripping devices should be able to compensate for differences of up to 2 cm in the part of the shelf to be gripped and still provide sufficient grip to retain the shelf during disconnection of the frame.

Preferably, for use with generally planar shelves, the gripping device comprises a pair of gripping elements movable parallel to the plane of the shelf to grip the shelf therebetween. The gripping device should then be able to grip each shelf sufficiently to exert a force in a direction normal to the plane of the shelf for lifting the shelf. It has been found that an inflatable element may be used to provide this gripping movement. This may occur by inflation of the element, by movement of the pre-inflated element towards the shelves or by a combination thereof.

In a preferred embodiment of the gripping device, there is provided an endless band mounted around rollers. The endless band extends vertically over at least the extent of the shelves and is displaceable laterally to grip the shelves e.g. against another similar band. The band may also be resilient or resiliently mounted in the lateral direction allowing it to compensate for variation in the shelf dimensions. This may be achieved by providing the gripping device with an inflatable tube. The inflatable tube may be mounted on the endless band and be inflatable for exerting pressure on the shelves. Alternatively, the inflatable tube may be stationary and mounted behind the band.

In order to controllably stack the shelves, the endless band may be driven to rotate around the rollers. Preferably, a pair of bands are driven to rotate in opposite directions whereby the shelves clamped between them are moved downwards. As each shelf reaches the lowermost roller it will become free and can drop onto a receiving position located below. This may be e.g. a stack or a form of transport device.

The present invention also relates to a method of dismantling a shelving unit, the shelving unit comprising a frame and a plurality of removable shelves supported by the frame, the method comprising: gripping the plurality of shelves to substantially restrain them against movement with respect to one another; removing the frame from the shelves; and controllably stacking the shelves. As mentioned above, by first immobilizing the shelves, it is more convenient to then remove or dismantle the frame. Once the frame has been removed, the shelves may more easily be stacked

According to an important feature of the method, the shelves may vary in their lateral dimensions and the gripping of the shelves takes place using a lateral force that is substantially independent of the lateral dimension. The shelves may thus all be gripped with a lateral force that is substantially equal.

The method may be practiced on a unit having a frame comprising a base and a plurality of supports mounted on the base, the shelves being suspended by the supports. In such case, the method may advantageously comprise applying a vertical force to the shelves to remove the supports from the base. In the context of the present invention, the term vertical and horizontal are used to describe the normal orientations with respect to such shelf units. It is nevertheless understood that the apparatus and method may be adapted to deal with shelving units that have been placed in other orientations.

### BRIEF DESCRIPTION OF THE DRAWINGS

An embodiment of the invention will now be described in further detail by way of example only, with reference to the attached figures in which:

FIG. 1 shows in perspective a flower trolley for use in the invention including a detail of the connection between shelves and uprights;

FIG. 2 shows a perspective view of an apparatus according to the invention in use for dismantling a flower trolley according to FIG. 1;

FIG. 3 shows a partial front elevation of the apparatus of FIG. 2 gripping a part of the trolley in which one of the uprights has been omitted;

FIG. 4 is a similar view to FIG. 3 after partially raising the apparatus and trolley;

FIG. 5 shows the apparatus after fully raising the apparatus and trolley;

FIG. 6 shows the apparatus after lateral displacement over an empty trolley;

FIG. 7 shows the apparatus after lowering of the gripping device above an empty trolley;

FIG. 8 shows the gripping device being driven to deposit the shelves; and

FIG. 9 shows a perspective view of the apparatus of FIGS. 2 to 8 including a support structure.

### DESCRIPTION OF ILLUSTRATIVE EMBODIMENTS

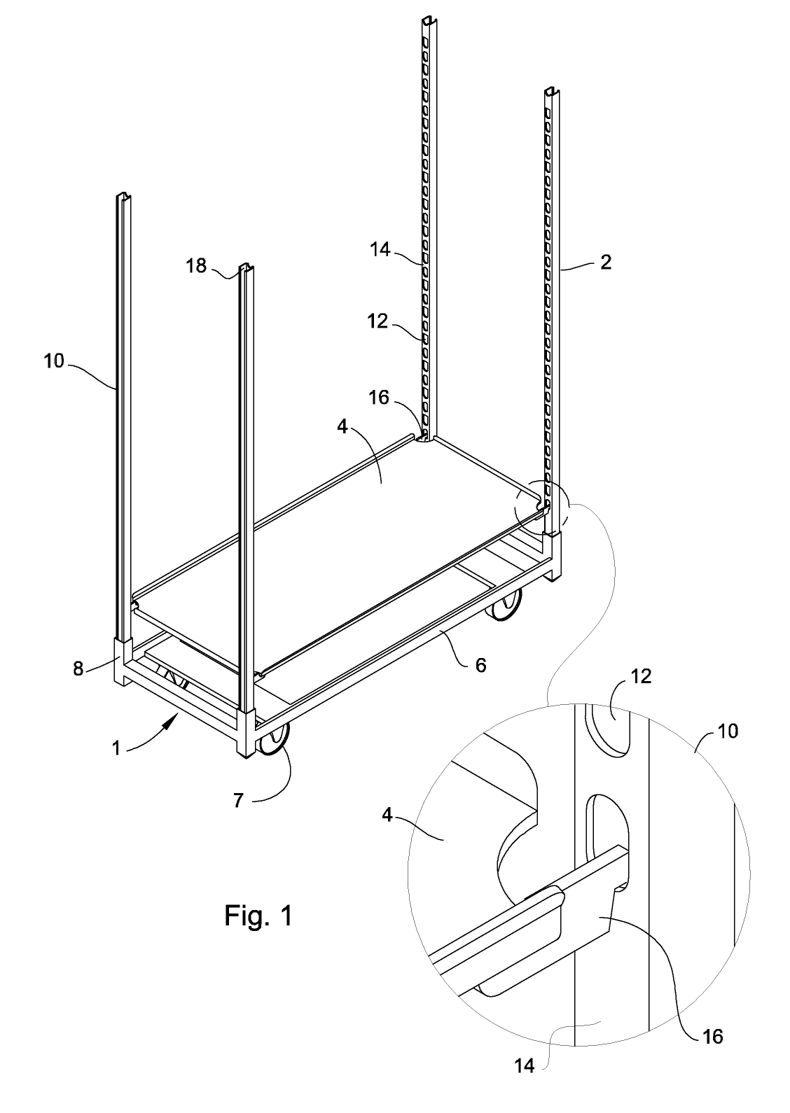

FIG. 1 shows a perspective view of a conventional trolley 1 as extensively used in the flower industry. The flower trolley 1 comprises a frame 2 and a plurality of generally planar shelves 4 mounted on the frame (for the sake of clarity only one shelf is depicted). In the present example, the frame comprises a base 6 mounted on wheels 7. At each corner of the base, a socket 8 is provided for receiving an upright 10. While the invention will be described further in relation to such a flower trolley, it will be immediately evident to the skilled person that the invention is also applicable to other forms of trolley or shelving unit. In this context, the term shelf is not considered limited to simple planar shelves or planks but may also include racks, baskets, cross-members and other such supporting devices that may require removal from a shelving system.

As can be seen in detail according to FIG. 1, each upright 10 comprises a generally U-shaped channel 18 with the bases 14 of the U-shaped channel facing inwards. The bases 14 are provided with elongate vertical slots 12 and the shelves 4 are provided with pins 16 that insert into the slots 12 to retain the shelves 4 at the desired height between the uprights 10. As will be further described below, the uprights 10 may be removed from the sockets 8 for stacking the trolley 1 for transport or storage. The uprights 10 may also be inserted into the sockets 8 with the bases 14 facing outwards. In this orientation, shelves 4 may be stacked on the trolley 1 with the pins 16 sliding into the open U-shaped channel 18 of the uprights 10.

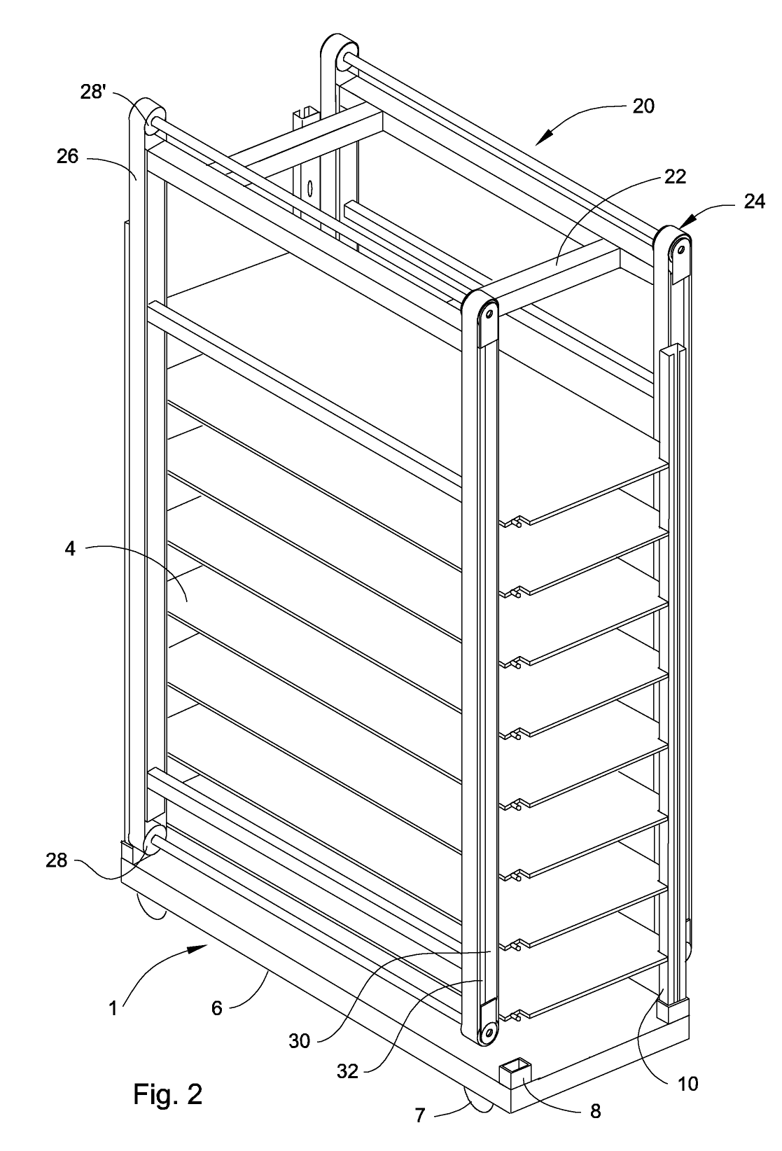

FIG. 2 shows a perspective view of an apparatus 20 according to the invention in a first stage of an operation to dismantle a trolley 1. One of the uprights 10 of the trolley 1 has been removed to better visualize the apparatus 20. As can be seen from FIG. 2, the apparatus 20 comprises a gripping device 22 comprising a number of gripping elements 24. In this embodiment, the gripping elements 24 are arranged in two pairs, one for each end of the trolley 1. It is however clear that a single pair of adequately dimensioned gripping elements 24 could be sufficient or that further gripping elements 24 could be provided e.g. for use with longer shelves.

Each gripping element 24 comprises an elongate band or belt 26 mounted for rotation around a pair of rollers 28, 28′. The belt 26 is driven to rotate by a drive (not shown) provided on the lower roller 28. The belt 26 is formed from an elastic material. Within the space defined between the belt 26 and the rollers 28, 28′ lies an inflatable tube 30.

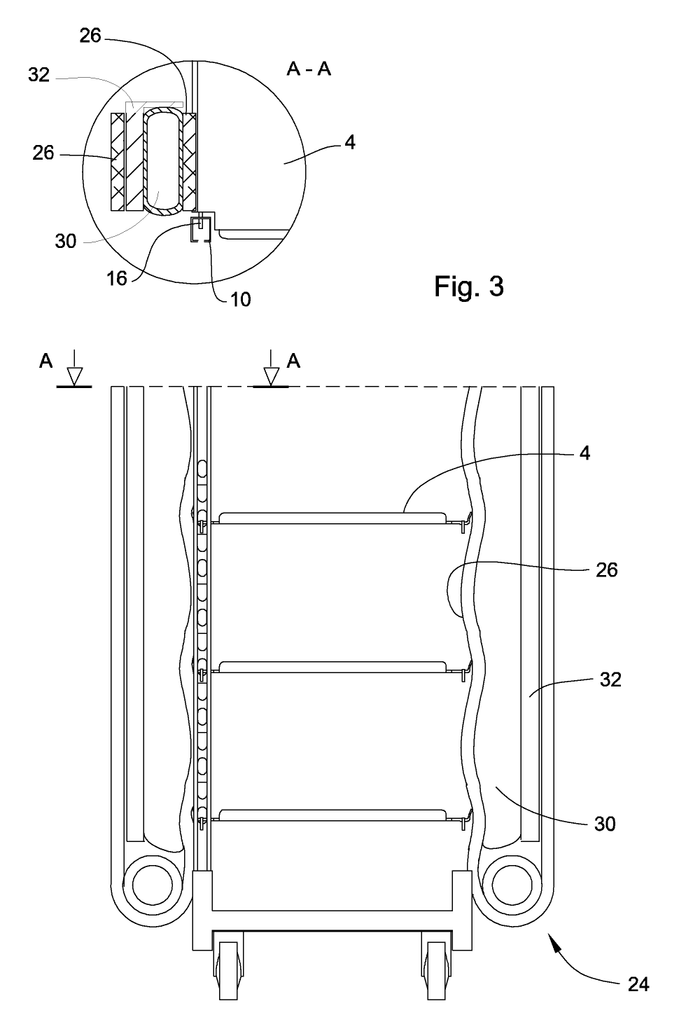

FIG. 3 shows a partial front view of FIG. 2 in which the gripping elements 24 have been actuated to grip the shelves 4. As can be seen from FIG. 3, inflatable tube 30 is supported by a backing plate 32 on the side distant from the shelves 4. The inflatable tube 30 may be inflated by means not shown causing the elastic belt 26 to distend and press outwards against the shelves 4. The distention of the belt 26 is sufficient to compensate for the differences in size of the shelves 4. Optionally, additional lateral movement of the complete gripping elements 24 towards one another may be provided.

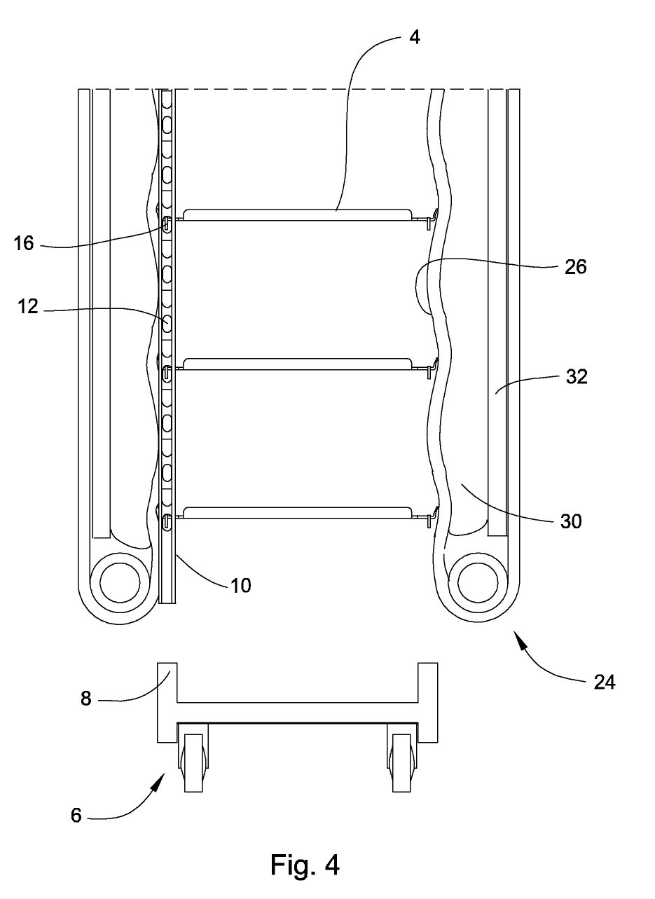

Operation of the apparatus of the invention will now be described with reference to FIGS. 4 to 8. As shown in FIG. 4, once the shelves 4 have been gripped, they may be lifted as a whole by upwards movement of the gripping elements 24. During this movement a retaining device (not shown) prevents the base 6 from being lifted. As a consequence, the uprights 10 are withdrawn from their sockets 8. In order to achieve this withdrawal, the gripping elements must exert sufficient force on each shelf to both lift the weight of the shelves 4 and also to disengage the upright 10 from the socket 8. It has been found that the combination of a belt, supported by an inflatable member 30 is extremely effective in achieving this combination of forces. In particular, the surface of the belt 26 should provide adequate grip to prevent slipping of the shelves, e.g. should one upright jam and cause an unequal load on the gripping elements 24. In the partially raised position of FIG. 4, the uprights 10 may then be removed from the shelves 4 by disengagement of the slots 12 and pins 16.

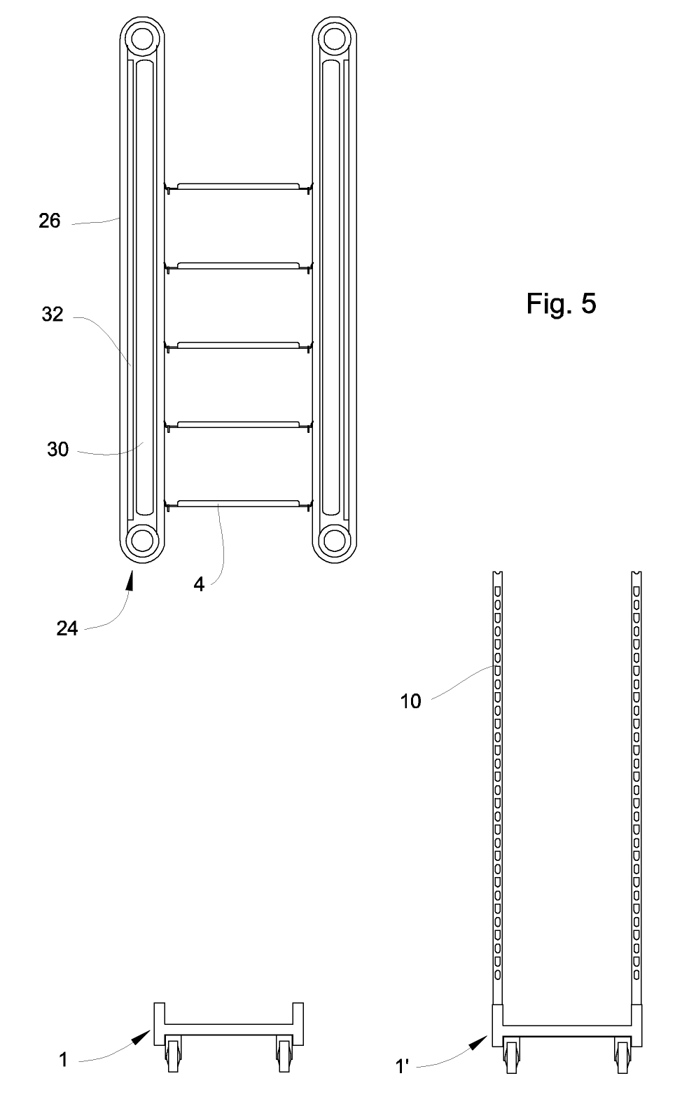

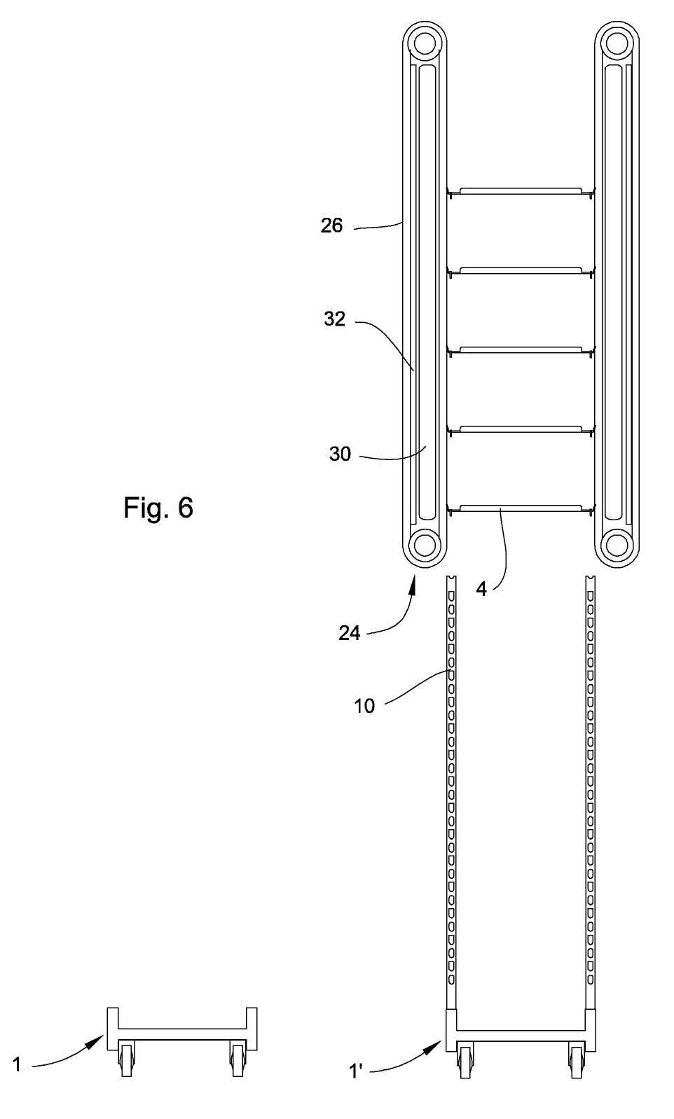

The shelves 4 and gripping elements 24 may then be displaced upwards as a unit to the position indicated in FIG. 5 and then laterally to the position of FIG. 6 in which they are located directly above an empty trolley 1′. The empty trolley 1′ is also provided with uprights 10. In this case however the uprights 10 have been reversed such that the U-shaped channel 18 is open towards the centre of the trolley.

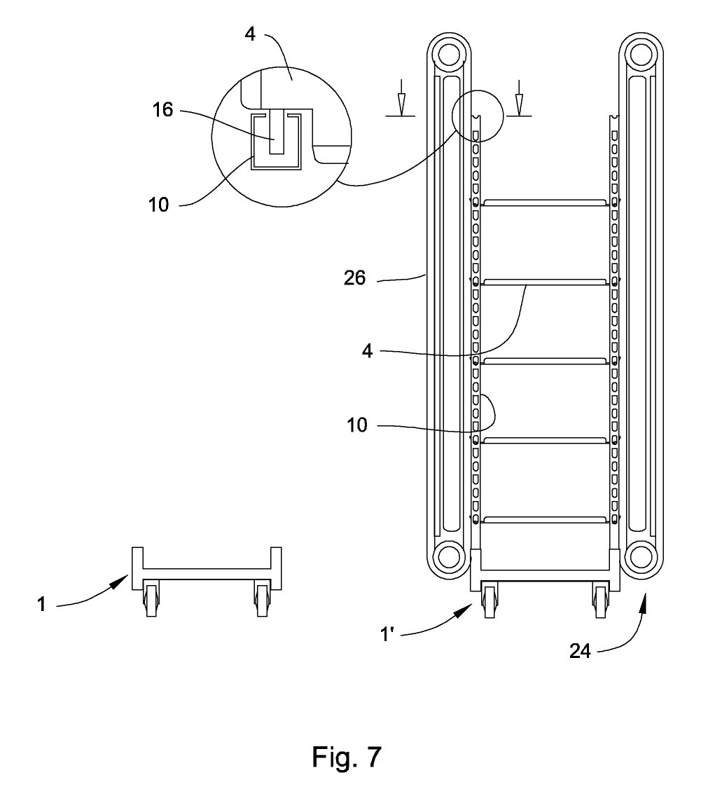

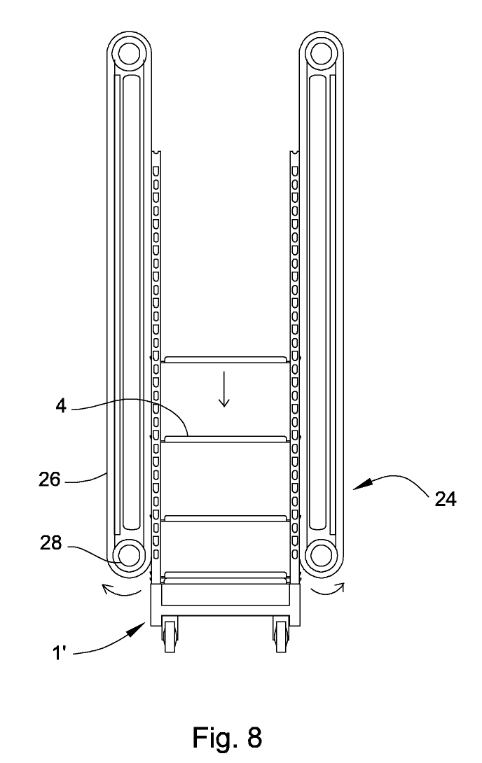

In FIG. 7, the apparatus has been lowered to bring the shelves 4 to a position slightly above the empty trolley 1′. During lowering of the shelves 4, the pins 16 are guided into the channels 18 thereby retaining the shelves 4 against sideways movement. At this point, according to FIG. 8, the gripping elements 24 may be operated to controllably deposit the shelves 4 one by one onto the empty trolley 1′ to form a stack. Operation of the gripping elements 24 takes place by rotation of roller 28 by the drive (not shown). This causes the part of the belt 26 gripping the shelves 4 to move downwards. As the lowermost shelf 4 reaches the level of the roller 28 it becomes free and can drop a short distance onto the trolley 1′ beneath. As the gripping elements 24 sequentially deposit the shelves to form a stack, appropriate sensors or registers measure the height of the stack or register the number of shelves and move the gripping elements 24 upwards to maintain an appropriate distance above the stack.

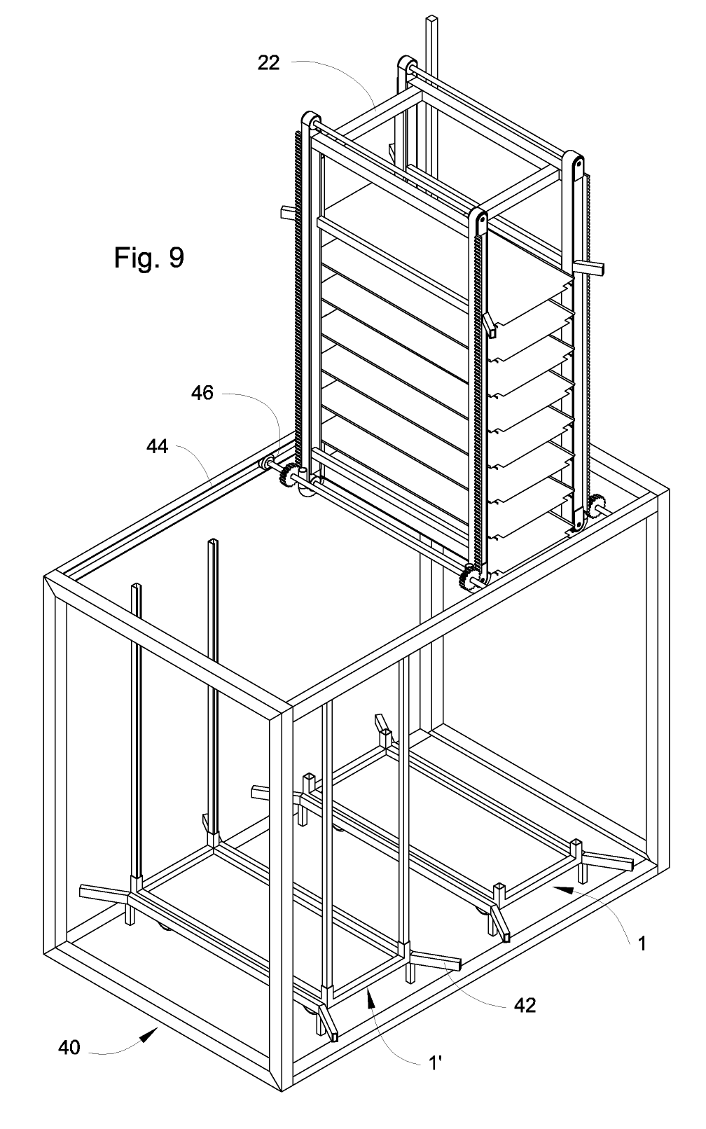

FIG. 9 depicts a perspective view of the apparatus according to FIGS. 2 to 8 showing further details of the apparatus including a support structure 40 for supporting the gripping device 22. The support structure 40 includes loading bays 42 for two trolleys 1, 1′ and transfer members 44 along which the gripping device 22 may be driven from one bay to the other by drive wheels 46. While the shelves are being deposited in one bay 42, a new trolley to be dismantled may already be positioned in the other bay. This is advantageous as the gripping device 22 may then be lowered over the trolley rather than requiring the trolley to be moved the bay with the gripping device already in position. In particular, by lowering the gripping device 22 onto the shelving unit, the gripping elements 24 may be allowed to rotate over the shelves 4. In this way, it is even possible to lower the gripping device 22 with the gripping elements 24 already inflated or otherwise in their gripping position.

In an alternative embodiment (not shown), a third loading bay may be provided for depositing broken or damaged shelves. The apparatus may then be provided with appropriate sensors for detecting such damage or may simply be provided with a manually activated device whereby an operator flags the location of a damaged shelf. On encountering a damaged shelf or flag, the gripping device ceases depositing the shelves on the empty trolley 1′ and moves to the third bay to deposit the damaged shelf. It then resumes normal operation.

While the present invention has been described in relation to the illustrated embodiment, it is to be understood that many alternatives and variations may be contemplated. Thus, prior to depositing the shelves, it may be convenient to locate spacers or the like in between them to facilitate later handling and reassembly thereof. Furthermore, instead of depositing the shelves on top of each other in a stack, it may be convenient to deposit them in a different manner e.g. vertically or onto a conveyor belt or similar device for further automated handling.

Although reference has been made to gripping elements comprising inflatable members, it is understood that other elements capable of gripping and retaining a plurality of shelves may also be used. The degree of flexibility of the gripping elements will depend on the expected size variation between shelves. The gripping force required (in a direction normal to the shelves) will depend on such factors as the weight of the shelves and the expected force needed to release elements of the frame. It is expected that a suitable stiff bristle or brush structure or a heavily profiled belt could also achieve the desired effect in certain cases.

While the above examples illustrate preferred embodiments of the present invention it is noted that various other arrangements may also be considered which fall within the spirit and scope of the invention as set out in the appended claims.

1. An apparatus for dismantling a shelving unit having a frame and a plurality of removable shelves supported by the frame, the apparatus comprising a gripping device for concurrently gripping the plurality of shelves to allow separation of the frame from the shelves, the gripping device being subsequently operable to controllably deposit the shelves.

2. The apparatus according to claim 1, further comprising a raising device for vertically displacing the gripping device and shelves as a unit with respect to at least part of the frame.

3. The apparatus according to claim 1, further comprising a transport device for laterally displacing the gripping device and shelves as a unit with respect to at least part of the frame.

4. The apparatus according to claim 1, wherein the shelving unit has shelves having differing dimensions and the gripping device comprises flexible jaws for gripping such shelves of differing dimensions.

5. The apparatus according to claim 1, wherein the shelves are generally planar and the gripping device comprises a pair of gripping elements movable parallel to the planes of the shelves to grip the shelves therebetween.

6. The apparatus according to any claim 1, wherein the shelves are generally planar and the gripping device grips each shelf sufficiently to exert a force in a direction normal to the plane of the shelf for releasing the shelf from at least part of the frame.

7. The apparatus according to any claim 1, wherein the gripping device comprises an endless band mounted around rollers.

8. The apparatus according to claim 7, wherein the endless band is driven to rotate to controllably deposit the gripped shelves.

9. The apparatus according to claim 1, wherein the gripping device comprises an inflatable tube.

10. A method of dismantling a shelving unit, the shelving unit comprising a frame and a plurality of removable shelves supported by the frame, the method comprising:
gripping the plurality of shelves to substantially restrain them against movement with respect to one another;
removing the frame from the shelves; and
controllably depositing the shelves.

11. The method of claim 10 wherein the shelves may vary in their lateral dimensions and the gripping of the shelves takes place using a force that is substantially independent of the lateral dimension.

12. The method according to any of claims 10 or 11, wherein the frame comprises a base and a plurality of supports mounted on the base, the shelves being suspended by the supports, and the method comprises applying a force to the shelves to remove the supports from the base.

13. The method according to claim 12, further comprising retaining the base while applying the force.

14. The method according to claim 11, wherein the action of controllably depositing the shelves comprises lowering the shelves sequentially to form a stack.

15. A system comprising in combination a shelving unit having a frame and a plurality of removable shelves supported by the frame, and an apparatus for dismantling the shelving unit according to any of claims 1 to 9, 17 or 18.

16. The system according to claim 15, wherein the shelving unit comprises a trolley provided with a plurality of wheels.

17. The apparatus according to claim 2 further comprising a transport device for laterally displaying the gripping device and shelves as a unit with respect to at least part of the frame.

18. The apparatus according to claim 7, wherein the gripping device comprises an inflatable tube.
